(19) United States
(12) Patent Application Publication
(10) Pub. No.: US 2004/0066894 A1
(43) Pub. Date: Apr. 8, 2004

(54) Device for x-ray analytical applications

(76) Inventors: Thomas Holz, Bundersrepublik (DE); Reiner Dietsch, Bundersrepublik (DE)

Correspondence Address: BARNES & THORNBURG, 11 SOUTH MERIDIAN, INDIANAPOLIS, IN, 46204

(21) Appl. No.: 10/467,785

(22) PCT Filed: Feb. 14, 2002
(86) PCT No.: PCT/DE02/00572

(30) Foreign Application Priority Data
Feb. 14, 2001 (DE) 101 07 914.1

(51) Int. Cl. G21K 1/06

(52) U.S. Cl. 378/84

(57) ABSTRACT

The invention relates to a device for X-ray analytical applications such as X-ray diffractometry, reflectometry and/or fluorescence analysis. The aim of the invention is to monochromatize, focus and optionally transform the X-radiation of a focal spot of a point of an X radiation source into a parallel, high photon density radiation in a highly precise manner. Parallel X radiation having a point-shaped primary beam cross-section is thus directed at a concavely curved, parabolic reflecting element which is used to focus and monchromatize the X radiation by means of a gradient and multilayered system embodied on the reflecting element. At least one screen is arranged between the X radiation source and the reflecting element.

The invention relates to an array for X-ray analytical applications which can be used, e.g., for the X-ray diffractometry, reflectometry and/or fluorescence analysis. Thus, for example, very small sample areas or inclusions being smaller than 1 mm within layers or a matrix are able to be also analyzed.

Compared with the natural crystals (e.g. Si, Ge, LiF, graphite) used for quite some time, X-ray optical elements having nanometer multilayers are used in the recent past for beam shaping and monochromatization in particular with photon energies E being greater than 3 keV, as this is described, for example, by T. W. Barbee Jr., “Multilayer for X-Ray Optical Applications”; X-Ray Microscopy; G. Schmahl, D. Rudolph; Springer Verlag Berlin, Heidelberg, New York, Tokyo; 1984; pp 144 to 162 and in WO 96/04665 A1. In some applications, these X-ray optical elements allow the substitution of the Bragg-Brentano-geometry required until then by means of the collimated beam geometry. Thereby, the intensity in the generated collimated beam was able to be increased by the use of parabolically curved gradient multilayers which are commonly indicated as Göbel mirrors. Such Göbel mirrors are offered commercially so far in X-ray reflectometers and diffractometers for various wavelengths as well. By the use of parallel X-rays, there can be achieved intensity gains having a factor of two to three, even in extreme cases having a factor of 10. In addition, the sample preparation and adjustment can be facilitated.

Thus far, the divergent and polychromatic X-radiation generated with a line focal spot of an X-ray beam source is converted into a collimated beam and is monochromatized simultaneously with such a Göbel mirror, as this is described by U. W. Arndt; Appl. Crystallograph. 23 (1990); pp 161 to 168 and in DE 44 43 853 A1 for Kα radiation. With these known solutions, the focus of the parabola is located within the line focal spots of the X-ray beam sources.

With X-ray beam sources having point focal spots, currently there are used two Göbel mirrors in a so-called Kirkpatrick-Baez-array which are turned to each other by 90° and arranged successively, as this is described by P. Kirpatrick, i.a. in J. Opt. Soc. Am.; 38 (1948), page 766, in which the focus of the two Göbel mirrors is located within the point focal spot of the X-ray beam source, herein.

For example, an array of two Göbel mirrors tilted to each other by 90° in an array developed similar thereto is known from U.S. Pat. No. 6,014,423 or U.S. Pat. No. 6,041,099, for example.

Ideal relations provided, such a parabolic Göbel mirror could image the X-rays having a wavelength of λ₀ and emanating divergently from the focal point as a collimated beam without any divergent portions. However, in reality the focal spot of an X-ray beam source has a finite dimension H such that the incident angles Θᵢ of individual X-rays at different locations Xᵢ each fluctuate by an amount of ΔΦᵢ, i.e. Θᵢ=Θ₀(xᵢ)±½ΔΘ(xᵢ). The angular dependence of reflectivity of the multilayer system of a Göbel mirror at the different locations Xᵢ cannot be described as well in the form of

R=f(Θᵢ)=R(Θᵢ)*δ(Θᵢ−Θ₀)

with

$$δ ( x ) = {\vert}_{0 ; x ‡0}^{1 ; x = 0}$$

It follows that:

R(Θᵢ)=0|Θᵢ‡Θ₀

R(Θᵢ)=R(Θ₀)|Θᵢ=Θ₀,

wherein Θ₀ is the angle of the first Bragg maximum. In reality, e.g. for Cu-Kα radiation, the Bragg maxima have a full width half maximum (FWHM) of (ΔΘᵢ)≈0.03° to 0.05°. By an equivalent back calculation it can be established proof that only portions of H up to approximately 50 μm can be completely imaged from the parabolic Göbel mirror with FWHMs above mentioned of Bragg maxima with predetermined λ₀. That means, using a point focal spot, that the dominant remaining surface of H generates false light of λ‡λ₀ which cannot be separated and very difficult, respectively, from the applicable radiation having the wavelength of λ₀. For this reason, X-ray optical devices generating collimated beams are almost used exclusively in combination with a line focus at lab X-ray beam sources. Only with a line focus having typical widths of H=0.04 mm, ΔΘ and ΔΦ have the same dimension. With the use of punctual primary beam source areas, e.g. the point focal spots of lab X-ray tubes, merely 5 to 10% of the focal spot can be used with a width of at least 0.4 mm in the horizontal direction and a height of 1.2 mm in the vertical direction such that high performance losses have to be accepted.

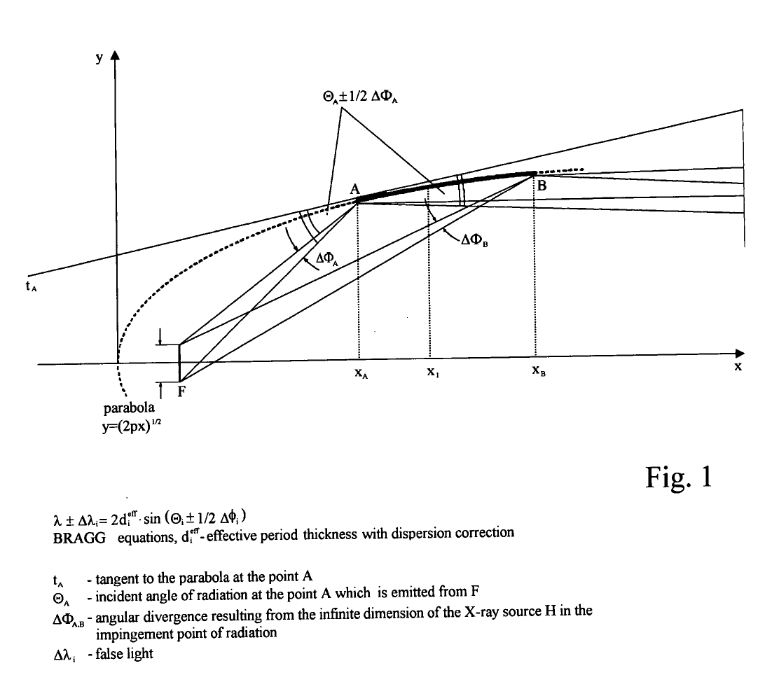

As a result, the applicable intensity of the selected wavelength of X-radiation is correspondingly low, and from the remaining area which represents 90 to 95% after all, false light Δλᵢ is superimposed to the parallel X-ray beam according to the Bragg equation. A corresponding beam guidance having the equivalent angles is shown in FIG. 1.

As for example, if the point focus of a lab X-ray beam source is applied across a surface of H*B=1.2*0.4 mm, then ΔΦ values in the order of magnitude of the first order Bragg angle can be achieved (ΔΦ is the angular divergence resulting from the finite dimension of the X-ray beam source H at the impingement point of the radiation on the multilayer system), i.e. ΔΦ≈Θᵢ, and ΔΦ>>ΔΘᵢ such that almost in each position the selected wavelength λ₀ of X-radiation is reflected from the multilayer system. With additional shutters in the optical path of X-radiation as well, it is very difficult only and impossible, respectively, to block out and adjust the desired parallel useful X-ray beam with λ₀ exactly, even with the use of an energy resolving detector.

In particular, for the use with the single-crystal diffractometry, due to the relatively small size of crystallite (diameter of <0.3 mm) it may be necessary, however, for the radiation of such small samples to use a punctual cross-section of the X-radiation preferably with diameters in the range of ≦0.5 mm.

In this case, the advantages of using well-known Göbel mirrors have not fully direct effect irrespective of whether radiation is used with a point focus or line focus. With the combination of Göbel mirror(s) and aperture plates having an opening of 0.5 mm, more than 90% of the intensity of the collimated beam (width of collimated beam of between 0.4 to 2 mm) of a line focal spot having a width of 12 mm will be absorbed, on the one hand, or it is allowed to use only appr. 5% of a point focal spot having a vertical H dimension of 0.4 to 1.2 mm, and a horizontal H dimension of 1.2 mm with the Göbel mirrors, as already explained in general. In addition, problems arise with the use of punctual primary radiation with respect to the required exact adjustment and false light suppression.

For these reasons, in the single-crystal diffractometry particular graphite monochromators (HOPG high-oriented pyrolytic graphite) have been employed thus far in combination with monocapillaries and aperture plates, respectively, as a rule. Thereby, the reflectivity of such a graphite monochromator, which in comparison with Göbel mirrors is lower by a factor of 3 to 4 during the monochromatization of X-radiation will be accepted, since the divergence of primary radiation is in the range of appr. 0.2° to 0.3°, thus appr. ten times greater than that of a Göbel mirror, according to the shutter used, whereby merely resolving can be decreased in all, however, a higher total photon flux can be achieved by means of aperture plates. In addition, this relatively great divergence/acceptance of a graphite monochromator balances the variations of position of the X-ray beam source focal spot (such as, e.g., rotating anodes) as the case may be. Such tilting of the individual graphite crystallites to each other in the graphite monochromator, which is called mosaic structure, ensures that each individual X-ray photon of the selected wavelength is allowed to impinge with high security upon a crystallite during its way through the graphite monochromator, wherein the useful planes thereof are located in a reflection position such that in the end the full cross-sectional area of a punctual focus can be imaged via the reflection on net planes.

Therefore, it is the object of the invention to suggest an array which is suitable for X-ray analytical application by means of which the X-radiation of a point focal spot of an X-ray beam source can be monochromatized, focussed and as the case may be converted into parallel X-rays of increased photon flux density with high accuracy.

This object is solved according to the invention with an array comprising the features of claim 1. Advantageous embodiments and improvements of the invention can be achieved with the features mentioned in the subordinate claims.

The array according to the invention uses almost parallel X-radiation emanating from a point focal spot of an X-ray beam source with a photon flux density which as generally known related to the beam height is higher than being the case with X-ray beam sources having a line shaped focal spot. In the optical path of the X-radiation, a shutter is arranged subsequent to the X-ray beam source which blocks out the portion of the X-radiation which is allowed to impinge immediately upon a sample without the influence of further X-ray optical elements, e.g. with the BRAGG-Brentano-geometry.

On that occasion, the point focal spot of the X-ray beam source should have a width (horizontally H) to height (vertically H) ratio of at least 4:1.

In the optical path subsequent to this shutter, there is positioned an X-ray optical element reflecting the X-radiation. This element is curved in a parabolic form, and therefore the X-radiation impinging upon this element an being reflected therefrom will be focussed. Furthermore, a gradient layer system is formed on the reflecting element, such as used with the Göbel mirrors known in the art as well. With the gradient multilayer system the impinging X-radiation can be monochromatized very well, irrespective of the impinging location on the reflecting element such that an X-radiation being free of undesired wavelengths can be generated which in this form is already usable for particular analysis techniques.

The already mentioned shutter which is provided between the X-ray beam source and the reflecting element is allowed to be developed as a primary shutter (e.g. vertical shutter, cutting shutter).

It is advantageous to provide a second shutter subsequent to the reflecting element, thus in the optical path of the focussed X-radiation, and to absorb with this shutter an X-radiation which is in the wavelength range being not desired for the respective analysis. It is particularly advantageous to arrange such a shutter that its aperture is provided in the focus of the respective predetermined wavelength λ₀ since in this case the greatest portion of the monochromatized X-radiation can be used, and X-radiation in the external wavelength range can be completely blocked out. The aperture dimension may be smaller than the common line width of lab X-ray beam sources, and effects a reduction of divergence with subsequent optical elements.

In addition, it is possible to provide subsequent to the first reflecting element a second reflecting element which is preferably curved concavely in a parabolic form and coated with a gradient multilayer system as well. With this reflecting element, the focussed divergent X-radiation can be converted back into a collimated beam which in comparison with the combination of line focus with Göbel mirrors has a greater photon flux density with respect to the usable beam height of maximum 1 mm such that this radiation can be effectively used for analysis purposes on small sample areas as well, and the measuring sensitivity can be increased. With such a second reflecting element the X-radiation can be monochromatized once again.

For detection purposes, the X-radiation influenced by the already mentioned X-ray optical elements is allowed to be directed upon a sample, and the X-radiation scattered by the sample can be detected with a detector wherein the distribution of intensity is detected as a function of the scattering angle, and/or an energy resolving detector is allowed to detect fluorescent radiation emanating from the sample.

With an array which uses two reflecting elements as already mentioned it is possible to achieve a compression of the beam cross-section of the parallel X-radiation. That means, that the beam width of X-rays emanating from the point focal spot of X-ray beam source is greater than the beam width of the parallel monochromatized X-radiation reflected from the second reflecting element, and hence the photon flux density can be increased thereby. With this, considering the reflectivity of the gradient multilayer system formed on the second reflecting element, a plurality of parameters can be consulted. This is, e.g. the parabolic form, the length of the two reflecting elements and/or the array thereof with respect to each other wherein the latter is the distance between the two reflecting elements in particular, since it determines the dimension of the image of X-radiation which has been reflected from the first reflecting element as divergent, focussed X-radiation on the second reflecting element.

With the array according to the invention, polychromatic X-radiation emanating from a point focal spot of an X-ray beam source and being parallel with respect to the divergence/acceptance of the first reflecting element can be almost converted completely into a monochromatic, collimated beam, and with the use of the two reflecting elements, into a punctual collimated beam without requiring the use of additional shutters, the apertures of which are smaller than the point focal spot of the X-ray beam source. Thereby, relatively small sample areas can be analyzed with a high local resolution. With such a development according to the invention, sample areas can be evaluated which are smaller than or equal to the respective point focal spot of the used X-ray beam source (e.g. lab X-ray tubes with stationary and rotating anodes, respectively, or transportable low-power electron tubes). In contrast with graphite monochromators known from the prior art, a divergence reduced by a factor 5, and therefore a more accurate resolution can be achieved in the imaging plane. In contrast to the known collimated beam optical devices the higher brilliance of point focal spots will be achieved for characterizing samples on surfaces which are less than or equal to the size of the respective point focal spot surface. In addition, usable intensity of X-radiation on the sample is considerably increased wherein particularly the greater reflectivity of the gradient multilayer systems compared with the lower reflectivity of the graphite monochromators, and the reduction of losses at the shutters favourably effect in connection with this.

Compared with the well-known arrays including Göbel mirrors at line focal spots there are no restrictions with respect to the minimum distance of a mirror to the electron tube focus then required which inherent in design result from the type of the tube protection housing. The first reflecting element can be joined to each electron tube housing of X-ray beam sources. There is no restriction with respect to the distance of the focus of X-ray beam sources to the first reflecting element since only the parallel portion of the emanating X-radiation is used.

The second reflecting element on which the divergent X-radiation is imaged in a line form and which will be available as a collimated beam after reflection, can be positioned with certain technically realizable layer thickness gradients in any close proximity past the line focal spot which has been generated with the first reflecting element.

Preferably, the second reflecting element is provided such that the positions of its focus and of the aperture of the shutter, which is positioned subsequent to the first reflecting element, correspond to each other. In particular, the combination of two collimated beam optical devices in the described form is suitable for compressing the beam cross-section, e.g. on radiation within the X-radiation range emanating from synchrotrons as well.

In the following the invention shall be described in more detail by way of example, wherein

FIG. 1 shows a diagrammatical representation of the angular relations of divergent X-radiation which is converted into parallel X-rays by means of Göbel mirrors, according to the prior art; and

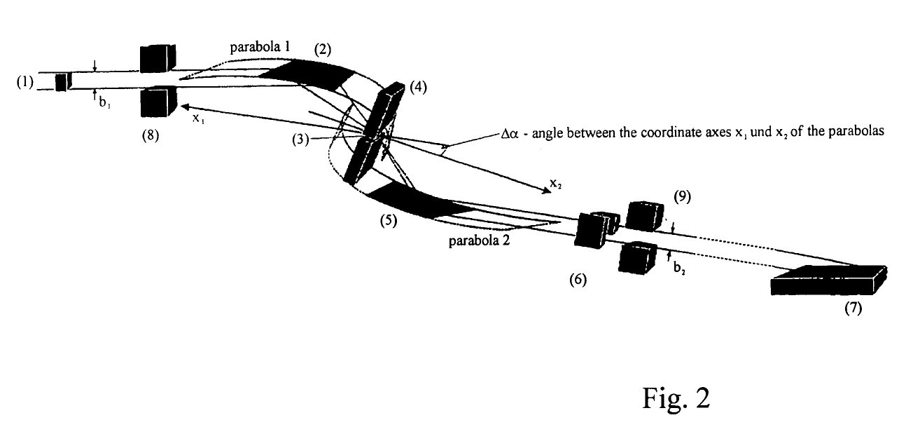

FIG. 2 shows the diagrammatical assembly for an embodiment of the array according to the invention.

With the embodiment of an array according to the invention shown in FIG. 2, parallel X-radiation having a punctual primary beam cross-section as well and emanating from a point focal spot of an X-ray beam source 1 is directed with a beam width b₁ (vertical dimension H) upon a parabolically curved reflecting element 2 on which a gradient multilayer system is developed. The reflecting element 2 is formed such as a well-known Göbel mirror wherein the dimensioning specifications for the respective desired parabolic form and the layout of suitable gradient multilayer systems are known such that an adaptation to the beam width of the punctual primary radiation, the selection of a pre-determinable X-radiation wavelength such as the position of the focus of the monochromatized X-radiation divergently reflected from the reflecting element 2 can be considered.

For blocking out X-radiation which is able to impinge upon a sample 7 immediately as a polychromatic radiation, a shutter 8 is positioned subsequent to the point focal spot of the X-ray beam source 1. The shutter 8 can be configured as a primary shutter by means of which X-radiation passing beneath the parallel punctual primary beam shown in FIG. 2 can be absorbed. As the case may be, the portion of shutter 8 which is positioned above this X-radiation as shown in FIG. 2 can be abandoned. Then, the shutter 8 is a so-called cutting shutter.

With the embodiment shown in FIG. 2 another shutter 4 is used by means of which the monochromatic X-radiation focussed in line form is allowed to be directed and blocked out with the X-radiation having undesired wavelengths which are absorbed by the shutter. Advantageously, the aperture of shutter 4 is positioned within the focus of X-radiation reflected from the reflecting element 2 at the predetermined wavelength.

For the development of a parallel monochromatic X-radiation which can used for analysis, a second reflecting element 5 which is also curved in a parabolic form and provided with a gradient multilayer system is positioned in the optical path of the divergent, monochromatic and focussed X-radiation.

If a shutter 4 is used with the array according to the invention, the second reflecting element 5 should also be positioned such that its focus corresponds with the focus 3 of the first reflecting element 2 as well, thus with the location of the aperture of shutter 4.

In the representation according to FIG. 2 it can be further seen that in accordance with the acceptance or divergence of the reflecting element 2 merely the portion of the polychromatic radiation emanating with the height H (b₁) in parallel of ΔΘ from the point focal spot of the X-ray beam source 1 will be monochromatized and reflected with the reflecting element 2 and focussed. The gradient multilayer system and the parabolic form of the reflecting element 2 are then selected such that the height H is smaller than or equal to the beam width b₁.

The aperture of the shutter 4 which, as already mentioned, should correspond to the focus is to be preferably selected such that the condition ΔΦ≦ΔΘ is fulfilled, wherein ΔΦ is the respective desired divergence of the radiation on the sample assuming an ideally curved second reflecting element 5 or further subsequent elements, and ΔΘ is the respective full width half maximum of the first order BRAGG maximum along the layer thickness gradients of the reflecting elements.

As a result of the imaging properties of the parabolas, low variations of position of the point focal spot of the X-ray beam source 1 within the beam width b₁ do not influence the location of focus 3 such that after the first reflection on the first reflecting element 2 a divergently radiating, monochromatic line source is to be noted on the shutter 4 (vertical shutter), the local stability of which is merely determined by the location of the reflecting element 2 and the shape thereof as well as the design of the gradient multilayer system.

If the second reflecting element is positioned such that its parabolic focus coincides with the focus 3, thus the location of the aperture of the vertical shutter 4, it is again allowed to achieve from the divergently radiating, monochromatic line source a point source which radiates monochromatically in parallel within the imaging plane as well.

The lengths and parabola parameters of the reflecting elements 2 and 5 as well as the distance to each other determine the beam width b₂ of the monochromatic parallel X-radiation subsequent to the reflecting element 5 which at a suitable choice of the available parameters can also result in a reduction of the beam width with regard to the beam width b₁ of the primary radiation used, and therefore in the increment of the photon flux density. With this, the condition has to be fulfilled that b₁/b₂*R(5)≧1, wherein R(5) is the mean reflectivity of the gradient multilayer system on the reflecting element 5.

The divergence of collimated X-rays reflected from the reflecting element 5 is determined orthogonally to the imaging plane by the size of the point focal spot of the X-ray beam source 1 and the size of the detector surface as well as by the distances of the individual elements. An additional limitation within this plane can be achieved by means of a horizontal shutter 6. The distance between this horizontal shutter 6 and the point focal spot of the X-ray beam source 1 can be varied within defined limits such that a beam divergence suitable for a measurement problem can be adjusted with a predetermined size of the point focal spot.

In contrast to the representation of FIG. 2, shutter 6 can also be positioned between the two reflecting elements 2 and 5.

An alternative with this is the development of shutter 4 with equivalent confinements of the slot on the sides.

For suppressing leakage X-radiation another vertical shutter 9 can be positioned between the reflecting element 5 and the sample 7 wherein the aperture of this vertical shutter 9 should correspond to the beam width b₂ of the parallel X-radiation emanating from the reflecting element 5.

### SUMMARY OF THE INVENTION

The invention relates to an array for X-ray analytical applications such as e.g. for X-ray diffractometry, reflectometry and/or fluorescence analysis. According to the object, the X-radiation of a point focal spot of an X-ray beam source is to be monochromatized, focussed and as the case may be, converted into parallel radiation of increased photon flux density with high accuracy. To solve this object, parallel X-radiation having a punctual primary radiation cross-section is directed upon a reflecting element concavely curved in a parabolic form wherein the X-radiation is focussed and monochromatized by means of a gradient multilayer system developed on the reflecting element. At least one shutter is positioned between the X-ray beam source and the reflecting element.

1. An array for X-ray analytical applications comprising an X-ray beam source and a reflecting, X-radiation focussing and monochromatizing element concavely curved in parabolic form, which is coated with a gradient multilayer system,
characterized in that parallel X-radiation having a punctual primary beam cross-section is directed upon the reflecting element (2), and the focussed monochromatized X-radiation is directed upon a sample, wherein a shutter (8) is positioned between an X-ray beam source (1) and said reflecting element (2).

2. An array according to claim 1,
characterized in that said shutter (8) is developed in the form of a primary shutter.

3. An array according to claims 1 or 2,
characterized in that a second shutter (4) is positioned in the focus (3) of said X-radiation focussed with said reflecting element (2).

4. An array according to any one of claims 1 to 3,
characterized in that a second concave, reflecting element (5) curved in a parabolic form, which is coated with a gradient multilayer system is provided, and which upon the divergent, monochromatized X-radiation from said first reflecting element (2) is directed for the generation of parallel X-radiation.

5. An array according to any one of claims 1 to 4,
characterized in that said second shutter (4) is positioned within said focus (3) of said second reflecting element (5).

6. An array according to any one of claims 1 to 5,
characterized in that at least one shutter (6, 9) is positioned between said second reflecting element (5) and said sample (7).

7. An array according to claim 6,
characterized in that said shutter(s) is (are) a horizontal shutter (6) and/or a vertical shutter (9).

8. An array according to any one of claims 1 to 7,
characterized in that the size of the aperture of said shutter (4) positioned subsequent to said first reflecting element (2) is selected for a predetermined wavelength λ₀ such that merely the parallel portion of the thus polychromatic radiation of the point focal spot of said X-ray beam source (1) with the divergence of ΔΦ as a function of the size of said shutter (4) reaches the sample through said shutter (4) wherein the condition ΔΦ≦ΔΘ₀ of the gradient multilayer system is fulfilled on each surface element of said first reflecting element (2).

9. An array according to any one of claims 1 to 8,
characterized in that the parabolic form, the length of said two reflecting elements (2, 5) and/or their arrangement with respect to each other are selected such that the beam width b₂ of said parallel X-radiation reflected from said second reflecting element (5) is smaller than the beam width b₁ of said primary radiation impinging upon said first reflecting element (2).

10. An array according to any one of claims 1 to 9,
characterized in that the intensity of X-radiation scattered from said sample (7) is detectable by a detector depending on the angle of scattering.

11. An array according to any one of claims 1 to 10,
characterized in that fluorescence radiation emanating from said sample (7) is detectable with a second detector.

12. An array according to any one of claims 1 to 11,
characterized in that said X-ray beam source (1) is a synchrotron, said point focal spot of a lab X-ray tube having a stationary anode or a rotating anode or said point focal spot of a transportable low-power electron tube.
